(19) United States
(12) Patent Application Publication
(10) Pub. No.: US 2020/0368826 A1
(43) Pub. Date: Nov. 26, 2020

(54) APPARATUS AND METHOD FOR INTEGRATION OF DRILLING AND INTERFERENCE-FIT PIN INSERTION

(71) Applicant: Northwestern Polytechnical University, Shaanxi (CN)

(72) Inventors: Kaifu Zhang, Shaanxi (CN); Junli Liu, Shaanxi (CN); Bin Luo, Shaanxi (CN); Hui Cheng, Shaanxi (CN); Yuan Li, Shaanxi (CN)

(21) Appl. No.: 16/096,021

(22) PCT Filed: Dec. 4, 2017
(86) PCT No.: PCT/CN2017/114447

§ 371 Date: Oct. 24, 2018

(30) Foreign Application Priority Data
Sep. 5, 2017 (CN) 201710791970.1

(51) Int. Cl. B23B 41/02; B64F 5/10

(52) U.S. Cl. CPC B23B 41/02; B64F 5/10

(57) ABSTRACT

An apparatus and method are provided for integration of drilling and interference-fit pin insertion. The apparatus includes a station switching module, a spindle module, and a pin insertion module. The station switching module is configured to drill and countersink a panel connecting hole. The pin insertion module is configured for interference-fit pin insertion of a hi-lock bolt. Hence, by using the apparatus, after the drilling of a hole to be drilled is completed, the station switching module is rotated by a fixed angle so that station states of the spindle module and the pin insertion module can be switched, the interference-fit pin insertion of the hi-lock bolts can be completed, and the anti-fatigue property and assembly efficiency can be improved.

### CROSS-REFERENCE TO RELATED APPLICATIONS

This application is a national phase entry of, and claims priority to International Application No. PCT/CN2017/114447, filed Dec. 4, 2017, which claims priority to Chinese Patent Application No. 201710791970.1, filed with the Chinese Patent Office on Sep. 5, 2017, both of which are incorporated herein by reference in their entireties.

### TECHNICAL FIELD

The present invention relates to the field of intelligent manufacturing and digital assembly, and in particular, to an apparatus and method for integration of drilling and interference-fit pin insertion, which are applied to a large-sized panel of an aircraft.

### BACKGROUND

Millions of rivets/bolts on aircraft made the step of drilling apertures for such rivets/bolts a very important part in assembly. Not only the strength of components thereof is weakened, but also stress concentrations are formed around the holes. In addition, the residual stress left during drilling has great impact on the ability of the parts to withstand alternating fatigue loads. To reduce those problems, interference-fit strengthening of connecting holes becomes an important technological measure to improve the fatigue life of the connecting structures. Nevertheless, at present, a riveting effector provided by the prior art can only achieve the functions of drilling, pin feeding, riveting and so on, and can complete the operation of riveting subsequent to drilling, thereby greatly improving the function of a robot by an automatic end effector. However, before the operation of drilling and riveting, a drilling position needs to be obtained again, and only rivet connection can be performed, but the interference-fit hi-lock bolt connection cannot be implemented.

In view of the above, how to implement the integration of drilling and interference-fit hi-lock bolt connection, improve the stress distribution of connecting holes under load and enhance the anti-fatigue performance in assembly, are urgent problems in the field of digital assembly. It would be desirable to improve the systems and methods for assembling components of aircraft using rivets and/or bolts.

### SUMMARY

The objectives of the present invention include to provide an apparatus and method for integration of drilling and interference-fit pin insertion, which are used for precise preparation of a panel connecting hole of an aircraft and interference-fit connection of a hi-lock bolt. On the basis of ensuring that each of several precision indexes, such as position precision, normal precision, surface roughness, and dimension precision, of a drilled hole can well meet the design requirements, a hole is drilled at a hole site needing interference-fit connection, and then a hi-lock bolt having a corresponding diameter is accurately inserted in the hole according to a predetermined interference amount, thereby implementing drilling and interference-fit connection of the hi-lock bolt, improving the stress distribution of a connecting hole under load, and enhancing the anti-fatigue performance and assembly efficiency.

In one embodiment of the invention, an apparatus for integration of drilling and interference-fit pin insertion is provided, which is connected with a robot. The apparatus for integration of drilling and interference-fit pin insertion includes: a station switching module, a spindle module, and a pin insertion module. The station switching module includes a driving mechanism, a dual-station connecting plate, and a connecting belt mechanism connected between the driving mechanism and the dual-station connecting plate. The connecting belt mechanism is fixedly connected with the dual-station connecting plate. The spindle module is provided at a first station of the dual-station connecting plate and is configured to drill and countersink a panel connecting hole. The pin insertion module is provided at a second station of the dual-station connecting plate and is configured for interference-fit pin insertion of hi-lock bolts. The driving mechanism of the station switching module drives the connecting belt mechanism to rotate, so as to implement station switching between the first station and the second station.

In one aspect, the station switching module further includes a dual-station supporting plate, a roller shaft collar, and a relative displacement sensor. The dual-station supporting plate is provided below the dual-station connecting plate and is configured to support the dual-station connecting plate. The dual-station connecting plate includes a first portion and a second portion. The roller shaft collar is embedded into the center of the first portion. The relative displacement sensor is provided at a side of the dual-station supporting plate. The driving mechanism includes a driving servomotor, a motor support, a bearing seat, a lead screw, and a nut seat in sequence. An external thread is provided outside one end of the nut seat. An internal thread is provided inside the connecting belt mechanism. The internal thread matches the external thread; the nut seat is connected with the connecting belt mechanism by the internal thread and the external thread matching each other. One end of the lead screw passes through the other end of the nut seat, and the other end of the lead screw passes through the bearing seat to connect with a coupling in the motor support and a motor shaft in the driving servomotor in sequence, and is configured to implement power connection between the dual-station connecting plate and the dual-station supporting plate, where the bearing seat is provided on the dual-station supporting plate.

In another aspect, the first portion is a hollow circular structure; the second portion is a sector structure, and an internal arc edge of the sector structure is fixedly connected with an external circular surface of the hollow circular structure. The first station and the second station are provided on the sector structure.

In a further aspect, the spindle module includes a spindle collet, an electric spindle, a WK tool shank, a drilling and countersinking integrated tool in sequence. The spindle collet is provided at the first station. The electric spindle passes through the spindle collet to connect with one end of the WK tool shank. The drilling and countersinking integrated tool is provided at the other end of the WK tool shank and is configured to drill and countersink a panel connecting hole.

In yet another aspect, the pin insertion module includes a pin insertion cylinder, a pin insertion spindle, a chuck connecting plate, and a bolt clamping portion in sequence. The pin insertion cylinder is provided at the second station. One end of the pin insertion spindle is coaxially connected with a cylinder piston rod shaft in the pin insertion cylinder, and the other end of the pin insertion spindle passes through the chuck connecting plate to connect with a pin insertion passage in the bolt clamping portion, for implementing interference-fit pin insertion of the high-lock bolts, where a hi-lock bolt altitude detection sensor is provided in the bolt clamping portion, and is configured to obtain altitude information of the hi-lock bolts.

In one aspect, the apparatus further includes a pin feeding module. The pin feeding module includes a pin feeding chuck passage, an end pin-feeding pipe, a pipe integrator, a hopper pin-feeding pipe, and a hopper device in sequence. The pin feeding chuck passage is connected with the pin insertion passage in the bolt clamping portion and is configured to supply hi-lock bolts of different specifications for the bolt clamping portion. One end of the pipe integrator is connected with the pin feeding chuck passage by the end pin-feeding pipe, and the other end of the pipe integrator is connected with the hopper device by the hopper pin-feeding pipe, where there are multiple hopper pin-feeding pipes; the hopper device is configured to store the hi-lock bolts of different specifications and automatically sort the hi-lock bolts.

In another aspect, the apparatus for integration of drilling and interference-fit pin insertion further includes a feed module. The feed module includes a robot connecting flange, a feed module supporting plate, as well as a first driving structure, a second driving structure, two sets of linear guide rails and accessories thereof, a plurality of sliding blocks and accessories thereof, an absolute grating ruler, and a guide rail hard limit stop which are provided on the feed module supporting plate. The robot connecting flange is connected with the robot. The feed module supporting plate is connected with the robot connecting flange. The first driving structure and the second driving structure are provided at the middle part of the feed module supporting plate, and the linear guide rails and accessories thereof are provided at two sides of the feed module supporting plate. The sliding blocks and accessories thereof are provided on the linear guide rails and accessories thereof. The first driving structure includes a spindle motor, a speed reducer, a first motor support, a first lead screw, and a first nut seat in sequence and is configured to achieve a transmission purpose of increasing torque and decreasing rotation speed. The second driving structure includes a presser foot motor, a second lead screw, and a second nut seat in sequence. A fixed portion of the absolute grating ruler is provided at a side of the feed module supporting plate. A movable read head of the absolute grating ruler is provided at a side of the dual-station supporting plate by a screw and is not located at the same side as the relative displacement sensor. The fixed portion is provided at the same side as the movable read head. The fixed portion cooperates with the movable read head for obtaining information about relative displacement between the dual-station module and the pressure foot normal leveling module when the relative displacement sensor is not within a measuring range. The guide rail hard limit stop is provided at the ends of the linear guide rails and accessories thereof close to the panel and is configured to prevent the dual-station module and the pressure foot normal leveling module from malfunctioning and slipping off, thereby ensuring safety, where the dual-station supporting plate is fixed on the first driving structure by the first nut seat, and is connected with the sliding blocks and accessories thereof to move the station switching module; the first driving structure is configured to provide power for feeding the station switching module along an axial direction of a drilled hole.

In yet another aspect, the apparatus for integration of drilling and interference-fit pin insertion further includes a pressure foot normal leveling module. The pressure foot normal leveling module includes a pressure foot supporting plate, a pressure foot provided at the middle of the pressure foot supporting plate and provided with a center hole, a pressure sensor, a relative displacement sensor contact wall structure, and laser sensors evenly arranged along the outer edge of the pressure foot. The pressure foot supporting plate is fixed above the second driving structure by the second nut seat and is connected with the sliding blocks and accessories thereof to move the pressure foot normal leveling module. The second driving structure is configured to provide power for feeding the pressure foot normal leveling module along the axial direction of the drilled hole. The laser sensor is configured to obtain information about a relative distance between the pressure foot and the panel. The pressure sensor is provided at a connecting bolt hole between the pressure foot and the pressure foot supporting plate and is configured to obtain a pressure value of the pressure foot pressing the panel. The relative displacement sensor contact wall structure is provided at a side of the pressure foot supporting plate and is located at the same side as the relative displacement sensor. The relative displacement sensor contact wall structure cooperates with the relative displacement sensor and is configured to obtain information about relative displacement between the dual-station module and the pressure foot normal leveling module, thereby precisely controlling a countersinking depth.

In another aspect, the apparatus for integration of drilling and interference-fit pin insertion further includes a visual alignment module and a cooling and dust collecting module, where the visual alignment module includes a visual device supporting plate, a visual camera and a visual light source support provided at two sides of the visual device supporting plate, and a visual light source portion supported by the visual light source support. The visual device supporting plate is provided on the pressure foot supporting plate. The visual camera is configured to obtain panel positioning pin/hole position information. The visual light source portion is connected with the end of the visual camera facing toward the panel and is configured to provide a light field for the visual camera. The cooling and dust collecting module includes a cooling pipe connector and a dust collecting pipe connector. The cooling pipe connector and the dust collecting pipe connector are symmetrically arranged about a vertical axis of the pressure foot. One end of the cooling pipe connector opens into the center hole of the pressure foot, and the other end is connected with a tool cooling and lubricating device disposed on a platform of the robot. The cooling pipe connector is configured to cool and lubricate a tool when the end effector drills a hole. One end of the dust collecting pipe connector opens into the center hole of the pressure foot, and the other end is connected with a dust collecting device disposed on the platform of the robot. The dust collecting pipe connector is configured to remove chips of the panel when the end effector drills the hole.

In another embodiment, the present invention further provides a method for integration of drilling and interference-fit pin insertion. The method for integration of drilling and interference-fit pin insertion includes: obtaining first positioning pin/hole position information of a panel; obtaining information about a first distance between a laser sensor and the panel; adjusting an altitude of a pressure foot normal leveling module according to the information about the first distance so that a deviation value of an angle between axes of the pressure foot normal leveling module and a positioning pin is less than a set value, and recording first altitude information of the pressure foot normal leveling module when the deviation value of the angle between axes of the pressure foot normal leveling module and the positioning pin is less than the set value; obtaining second positioning pin/hole position information of the panel; obtaining information about a second distance between the laser sensor and the panel; adjusting the altitude of the pressure foot normal leveling module according to the information about the second distance so that a deviation value of an angle between axes of the pressure foot normal leveling module and the positioning pin is less than a set value, and recording second altitude information of the pressure foot normal leveling module when the deviation value of the angle between axes of the pressure foot normal leveling module and the positioning pin is less than the set value; calculating the position coordinate of a hole to be drilled by using a linear interpolation algorithm according to the first positioning pin/hole position information, the first altitude information, the second positioning pin/hole position information, and the second altitude information; and controlling the spindle module to drill and countersink the hole to be drilled according to the position coordinate of the hole to be drilled, and controlling, after the hole to be drilled is drilled and countersunk, the station switching module to switch stations of the spindle module and the pin insertion module, so as to control the pin insertion module to perform interference-fit connection of hi-lock bolts.

The present invention achieves the following technical objects and advantages. The present invention provides an apparatus and method for integration of drilling and interference-fit pin insertion. The apparatus is connected with a robot. The apparatus for integration of drilling and interference-fit pin insertion includes: a station switching module, a spindle module, and a pin insertion module; the station switching module includes a driving mechanism, a dual-station connecting plate, and a connecting belt mechanism connected between the driving mechanism and the dual-station connecting plate; the connecting belt mechanism is fixedly connected with the dual-station connecting plate; the spindle module is provided at a first station of the dual-station connecting plate, and is configured to drill and countersink a panel connecting hole; the pin insertion module is provided at a second station of the dual-station connecting plate, and is configured for interference-fit pin insertion of a hi-lock bolt; the driving mechanism of the station switching module drives the connecting belt mechanism to rotate, so as to implement station switching between the first station and the second station. Hence, the present invention implements the interference-fit pin insertion of the hi-lock bolts by providing the pin insertion module. By providing the station switching module and rotating the station switching module by the fixed angle to switch the station states of the spindle module and the pin insertion module, the present invention overcomes the defect of searching for pin insertion hole position information again during pin insertion and achieves the purpose of integration of drilling and interference-fit pin insertion. Therefore, by using the apparatus and method of the present invention, on the basis of ensuring that each of precision indexes, such as position precision, normal precision, surface roughness, and dimension precision, of a drilled hole can well meet the design requirements, a hole can be drilled at a hole site needing interference-fit connection, and then a hi-lock bolt having a corresponding diameter can be accurately inserted in the hole according to a predetermined interference amount, so as to achieve of the purpose of integration of drilling and interference-fit connection of the hi-lock bolt, improving the stress distribution of a connecting hole under load, and enhancing the anti-fatigue performance and assembly efficiency.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrates one or more embodiments of the invention and, together with the general description given above and the detailed description given below, explains the one or more embodiments of the invention.

FIG. 1 is a perspective view of an apparatus for integration of drilling and interference-fit pin insertion according to one embodiment of the invention.

FIG. 2 is a left view of the apparatus of FIG. 1.

FIG. 3 is a top view of the apparatus of FIG. 1.

FIG. 4 is a perspective view of a station switching module according to one embodiment of the invention.

FIG. 5 is a perspective view of a dual-station connecting plate according to one embodiment of the invention.

FIG. 6 is a perspective view of a dual-station supporting plate according to one embodiment of the invention.

FIG. 7 is a perspective view of a spindle module according to one embodiment of the invention.

FIG. 8 is a perspective view of a pin insertion module according to one embodiment of the invention.

FIG. 9 is a perspective view of a pin feeding module according to one embodiment of the invention.

FIG. 10 is a perspective view of a feed module according to one embodiment of the invention.

FIG. 11 is a perspective view of a feed module supporting plate according to one embodiment of the invention.

FIG. 12 is a perspective view of a pressure foot normal leveling module according to one embodiment of the invention.

FIG. 13 is a perspective view of a pressure foot supporting plate according to one embodiment of the invention.

FIG. 14 is a perspective view of a visual alignment module according to one embodiment of the invention.

FIG. 15 is a perspective view of a cooling and dust collecting module according to one embodiment of the invention.

FIG. 16 is a schematic flow chart showing several steps of a method for integration of drilling and interference-fit pin insertion according to another embodiment of the invention.

### DETAILED DESCRIPTION

Embodiments of the invention are illustrated below with reference to the accompanying drawings. The preferred embodiments described here are used only to describe and explain the present disclosure, but not to limit the present disclosure. All other embodiments obtained by a person of ordinary skill in the art without creative efforts on the basis of the embodiments of the present invention shall fall within the scope of protection of the present invention.

An automatic drilling and connection technology for a panel is an advanced technology for implementing single-point fully intelligent assembly and connection of products in an intelligent manufacturing environment of the workshop. By equipment supporting workpieces with high rigidity and flexibility, a precise product panel error identification and positioning technology in combination with repeatedly researched and optimized drilling and interference-fit pin insertion process parameters, effectively controls the machining error, implements direct interference-fit connection subsequent to drilling of the panel, improves the assembly efficiency of a large-sized panel, eliminates coaxial alignment errors caused to prepared lamination holes by multiple positioning during drilling and connection of the products, improves the assembly precision, promotes the development of a precise assembly and connection technology for aircraft panels, basically implements single-point intelligent manufacturing in the workshop, and lays the foundation for the implementation of comprehensive intelligent manufacturing.

There are 1.5 to 2 million rivet/bolt connectors on an aircraft, and mechanical connections require drilling holes in the parts. For the parts, not only the strength thereof is weakened, but also stress concentrations are formed around the holes. In addition, the residual stress left during drilling has great impact on the ability of the parts to withstand alternating fatigue loads. To reduce the impact, interference-fit strengthening of connecting holes becomes an important technological measure to improve the fatigue life of the connecting structures. The interference-fit connection of hi-lock bolts is just a common interference-fit strengthening technology. At present, interference-fit bolt connection is mostly completed manually, the workload is large, the work efficiency is low, and the quality after the connection is uneven.

Accordingly, the objectives of the present invention are to provide an apparatus and method for integration of drilling and interference-fit pin insertion, which are used for precise preparation of a panel connecting hole of an aircraft and interference-fit connection of a hi-lock bolt. On the basis of ensuring that each of precision indexes, such as position precision, normal precision, surface roughness, and dimension precision, of a drilled hole can well meet the design requirements, a hole can be drilled at a hole site needing interference-fit connection, and then a hi-lock bolt having a corresponding diameter can be accurately inserted in the hole according to a predetermined interference amount, thereby implementing drilling and interference-fit connection of the hi-lock bolt, improving the stress distribution of a connecting hole under load, and enhancing the anti-fatigue performance and assembly efficiency.

In order to make the above objectives, features, and advantages of the present invention clearer, the present invention will be further described in detail below in combination with the accompanying drawings and specific embodiments.

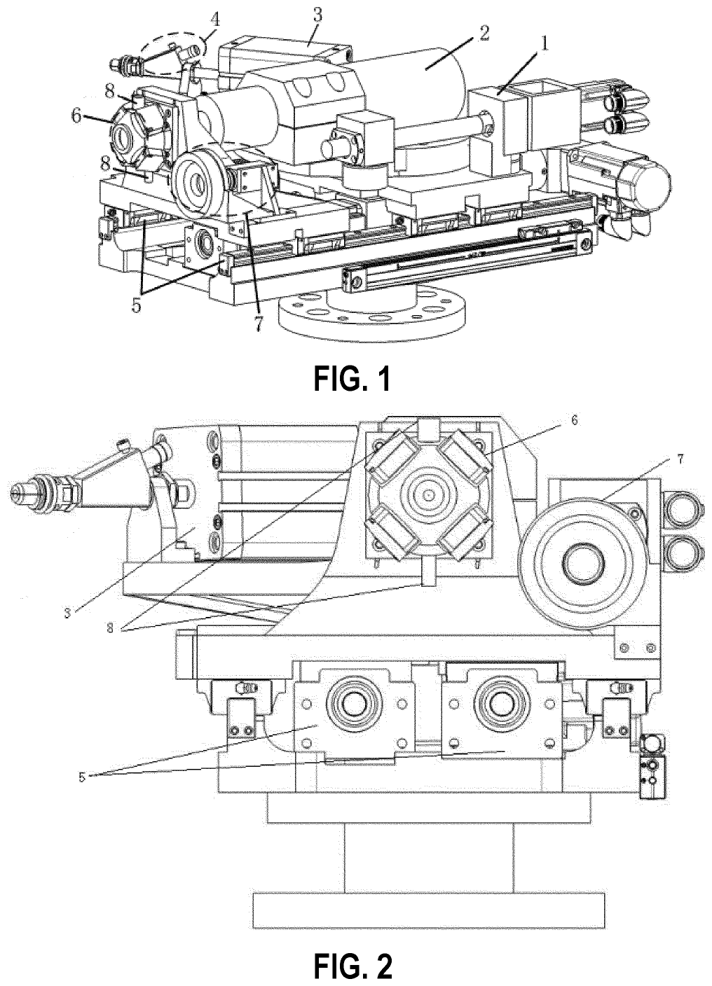

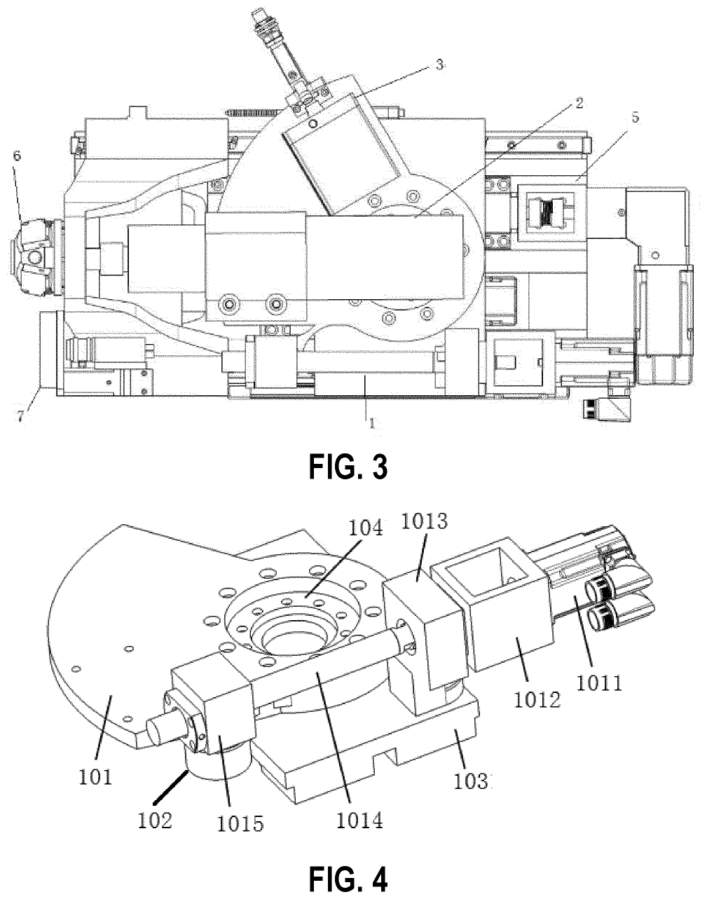

FIG. 1 is a three-dimensional schematic structural diagram of an apparatus for integration of drilling and interference-fit pin insertion according to an embodiment of the present invention; FIG. 2 is a left view of FIG. 1; and FIG. 3 is a top view of FIG. 1. As shown in FIGS. 1-3, the apparatus for integration of drilling and interference-fit pin insertion provided by the present invention specifically includes the following structures: a station switching module 1 (also referred to as a dual-station module 1 herein), a spindle module 2, a pin insertion module 3, an automatic pin feeding module 4, a feed module 5, a pressure foot normal leveling module 6, a visual alignment module 7, and a cooling and dust collecting module 8. The spindle module 2 is mainly configured to drill/countersink holes in a product; an electric spindle clamping device and a spindle connecting structure are reasonably designed and precisely designed while taking into consideration the dead weights and clamping rigidities and stabilities thereof, thereby ensuring the rotation precision of an electric spindle and radial run-out of a tool, and ensuring that the diameter tolerance of a drilled hole is within the design specification. The pin feeding module 4 consists of a bolt classification hopper device, a pneumatic pin feeding unit, a split pin feeding pipe and a control unit thereof and is configured to feeding a hi-lock bolt of a corresponding specification into a clamping device of the pin insertion module 3 at an appropriate time before pin insertion. The pin insertion module 3 is configured to insert the automatically conveyed high-lock bolt into a prepared connecting hole according to a certain interference amount. The station switching module 1 is configured to precisely switch the spindle module 2 and the pin insertion module 3 to a processing station or an idle station, and precisely control the rotation angle by using a high-precision absolute rotary encoder provided in a driving servomotor, in order to ensure the coaxial alignment between the axis of an execution shaft on the processing station and the axis of an inner hole of a pressure foot. The feed module 5 is configured to ensure the spindle module 2, the pin insertion module 3, and the pressure foot normal leveling module 6 to move along the axial direction of the drilled hole, precisely feed a moving unit by using a measurement and feedback submodule consisting of an absolute displacement grating ruler, a relative displacement sensor and a force sensor and by applying a full closed loop control technology, and provide an appropriate pressure for a pressure foot to press a panel. The pressure foot normal leveling module 6 is configured to ensure normal vector angle precision during drilling and pin insertion, also ensure the stability of the panel in a machining process and eliminate the impact of factors such as product shake and deformation on the machining quality. The visual alignment module 7 can accurately measure the deviation between the projection point of a spindle axis on the panel and the theoretical hole site, and feed back the deviation to the control system; the point deviation is corrected by using a closed loop control technology, to ensure the position precision of a machined hole. The cooling and dust collecting module 8 is configured to cool and lubricate a tool and remove cutting scraps in time during a drilling process, thereby preventing residual cutting scrapes from scrapping the product while ensuring the normal temperature of a drilling region, so that the safety of the product and smooth-going of the machining process are ensured.

FIG. 4 is a schematic structural diagram of a station switching module according to an embodiment of the present invention. As shown in FIG. 4, the station switching module 1 includes a driving mechanism, a dual-station connecting plate 101, and a connecting belt mechanism 102 connected between the driving mechanism and the dual-station connecting plate. The connecting belt mechanism 102 is fixedly connected with the dual-station connecting plate 101. The spindle module 2 is provided at a first station of the dual-station connecting plate 101 and is configured to drill and countersink a panel connecting hole. The pin insertion module 3 is provided at a second station of the dual-station connecting plate 101 and is configured for interference-fit pin insertion of a hi-lock bolt. The driving mechanism of the station switching module 1 drives the connecting belt mechanism 102 to rotate, so as to implement station switching between the first station and the second station.

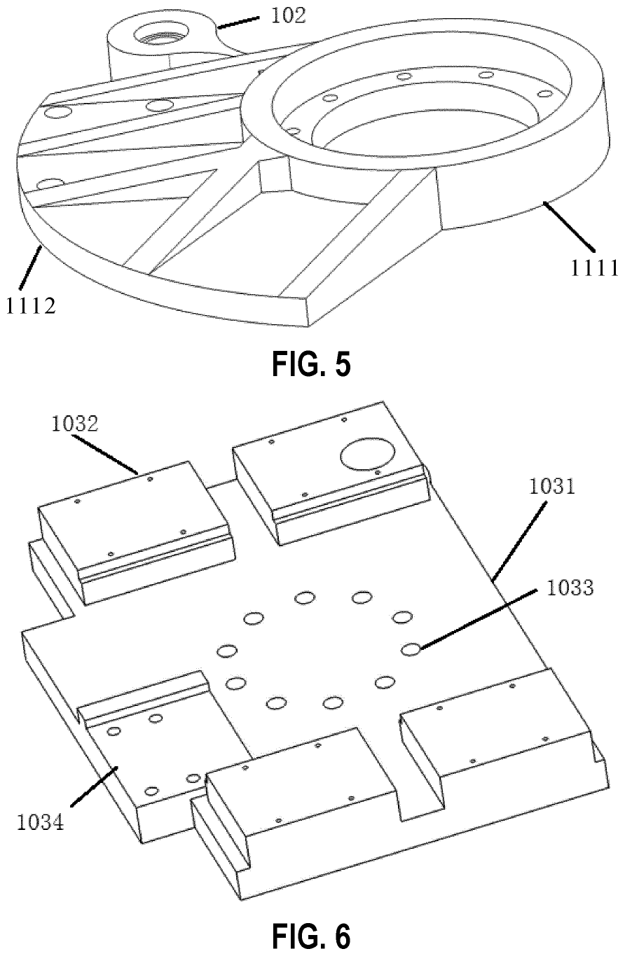

FIG. 5 is a schematic structural diagram of a dual-station connecting plate according to an embodiment of the present invention. As shown in FIG. 5, the dual-station connecting plate 101 includes a first portion 1111 and a second portion 1112. The first portion 1111 is a hollow circular structure. The second portion 1112 is a sector structure, and an internal arc edge of the sector structure is fixedly connected with an external circular surface of the hollow circular structure. The first station and the second station are provided on the sector structure.

As shown in FIG. 4, the station switching module 1 further includes a dual-station supporting plate 103, a roller shaft collar 104, and a relative displacement sensor. The roller shaft collar 104 is embedded into the center of the first portion 1111 and is configured to ensure the degree of freedom of relative rotation of the dual-station connecting plate 101, and bear axial and radial loads. The dual-station supporting plate 103 is provided below the dual-station connecting plate 101 and is configured to support the dual-station connecting plate 101. The relative displacement sensor is provided at a side of the dual-station supporting plate 103 by a screw and can axially move along the drilled hole along with the station switching module 1.

FIG. 6 is a schematic structural diagram of a dual-station supporting plate according to an embodiment of the present invention. As shown in FIG. 6, the dual-station supporting plate 103 includes a dual-station supporting portion 1031, a plurality of sliding block and accessory mounting portions 1032, a plurality of mounting holes 1033, and a first nut seat mounting portion 1034. The sliding block and accessory mounting portions 1032 are provided at two sides of the dual-station supporting portion 1031 and are configured to mount sliding blocks and accessories thereof in the feed module 5 at this position. The plurality of mounting holes 1033 is circularly distributed at the center of the dual-station supporting portion 1031 and is configured to mount the roller shaft collar 104 at this position. The first nut seat mounting portion 1034 is provided on the dual-station supporting portion 1031 and adjacent to the sliding block and accessory mounting portions 1032 and is configured to mount the first nut seat of the feed module 5 at this position.

As shown in FIG. 4, the driving mechanism includes a driving servomotor 1011, a motor support 1012, a bearing seat 1013, a lead screw 1014, and a nut seat 1015 in sequence. An external thread is provided outside one end of the nut seat 1015. An internal thread is provided inside the connecting belt mechanism 102. The internal thread matches the external thread. The nut seat 1015 is connected with the connecting belt mechanism 102 by the internal thread and the external thread matching each other. One end of the lead screw 1014 passes through the other end of the nut seat 1015, and the other end of the lead screw 1014 passes through the bearing seat 1013 to connect with a coupling in the motor support 1012 and a motor shaft in the driving servomotor 1011 in sequence, for ensuring good coaxial alignment between the motor shaft as well as the coupling and the lead screw shaft, and implementing power connection between the dual-station connecting plate and the dual-station supporting plate, where the bearing seat 1013 is provided on the dual-station supporting plate 103.

The station switching module drives the dual-station connecting plate 101 to rotate through a simple linkage principle, to implement station switching. A high-precision absolute rotary encoder is provided in the driving servomotor 1011, and is configured to precisely control the rotation angle and ensure the coaxial alignment between the axis of an execution shaft (the spindle module 2 or the pin insertion module 3) on the processing station and the axis of a center hole of a pressure foot in the pressure foot normal leveling module 6.

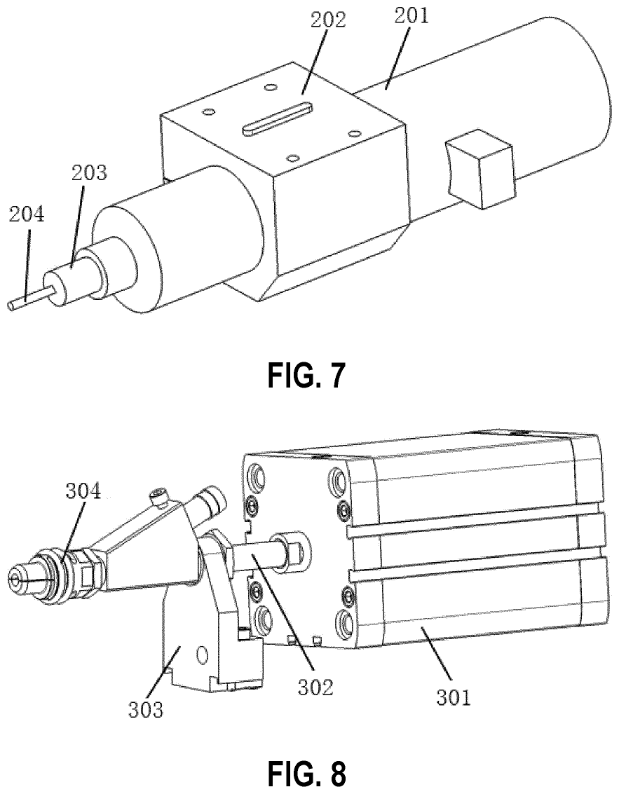

FIG. 7 is a schematic structural diagram of a spindle module according to an embodiment of the present invention. As shown in FIG. 7, the spindle module 2 includes an electric spindle 201, a spindle collet 202, a WK tool shank 203, a drilling and countersinking integrated tool 204 in sequence. The spindle collet 202 is provided at the first station. The electric spindle 201 passes through the spindle collet 202 to connect with one end of the WK tool shank 203. The drilling and countersinking integrated tool 204 is provided at the other end of the WK tool shank 203 and is configured to drill and countersink a panel connecting hole.

FIG. 8 is a schematic structural diagram of a pin insertion module according to an embodiment of the present invention. As shown in FIG. 8, the pin insertion module 3 includes a pin insertion cylinder 301, a pin insertion spindle 302, a chuck connecting plate 303, and a bolt clamping portion 304 in sequence. The pin insertion cylinder 301 is provided at the second station. One end of the pin insertion spindle 302 is coaxially connected with a cylinder piston rod shaft in the pin insertion cylinder 301, and the other end of the pin insertion spindle 302 passes through the chuck connecting plate 303 to connect with a pin insertion passage in the bolt clamping portion 304, for implementing interference-fit pin insertion of the high-lock bolt. A hi-lock bolt altitude detection sensor is provided in the bolt clamping portion 304, and is configured to obtain altitude information of the hi-lock bolt, and adjust the hi-lock bolt according to the altitude information, in order to temporarily clamp the hi-lock bolt in a fixed altitude, and ensure the hi-lock bolt to be in a correct to-be-inserted altitude before being inserted into a pin hole, thereby ensuring that a pin insertion operation is performed only on the premise that the hi-lock bolt is correctly conveyed, and guaranteeing the safety of a pin insertion process.

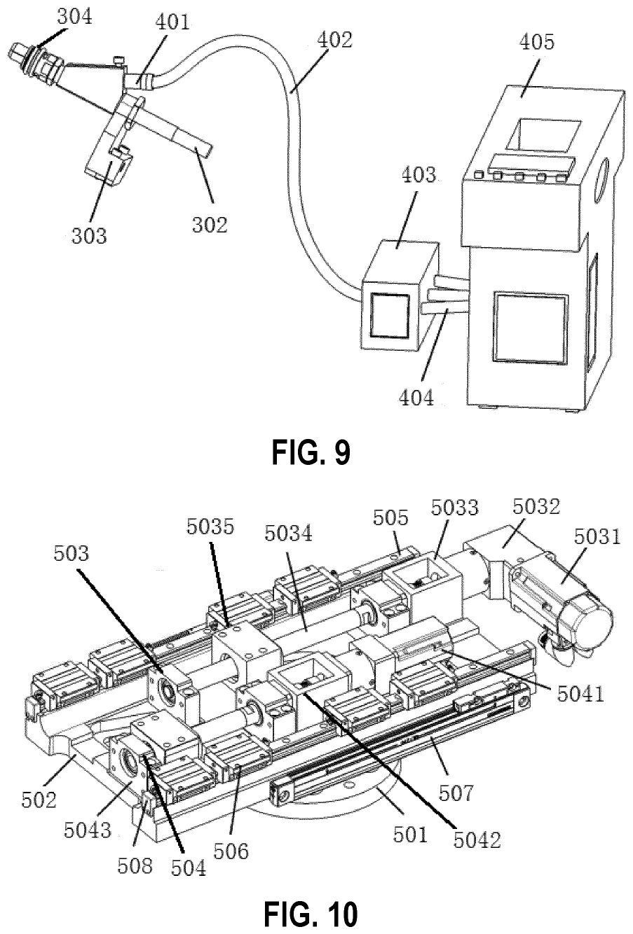

FIG. 9 is a schematic structural diagram of a pin feeding module according to an embodiment of the present invention. As shown in FIG. 9, the pin feeding module 4 include a pin feeding chuck passage 401, an end pin-feeding pipe 402, a pipe integrator 403, a hopper pin-feeding pipe 404, and a hopper device 405 in sequence, and is configured to supply hi-lock bolts of different specifications for an end effector. The pin feeding chuck passage 401 is connected with the pin insertion passage in the bolt clamping portion 304 and is configured to supply hi-lock bolts of different specifications for the bolt clamping portion. One end of the pipe integrator 403 is connected with the pin feeding chuck passage 401 by the end pin-feeding pipe 402, and the other end of the pipe integrator 403 is connected with the hopper device 405 by the hopper pin-feeding pipe 404. There are multiple hopper pin-feeding pipes 404. The hopper device 405 is disposed in a table feeding region so that a worker puts the hi-lock bolts therein and is configured to store the hi-lock bolts of different specifications and automatically sort the hi-lock bolts. The pipe integrator 403 is configured to supply the hi-lock bolts of different specifications to the pin insertion module 3 by the end pin-feeding pipe 402 after receiving the hi-lock bolts, and detect the altitude of each hi-lock bolt, thereby ensuring that all the received hi-lock bolts are consistent in altitude, and avoiding a product damage accident caused by incorrect altitude of the hi-lock bolts. The entire pin feeding module 4 is disposed on an equipment table, and only the pin feeding chuck passage 401 is connected with the pin insertion module 3 by the end pin-feeding pipe 402.

FIG. 10 is a schematic structural diagram of a feed module according to an embodiment of the present invention. As shown in FIG. 10, the feed module 5 includes a robot connecting flange 501, a feed module supporting plate 502, as well as a first driving structure 503, a second driving structure 504, two sets of linear guide rails and accessories thereof 505, a plurality of sliding blocks and accessories thereof 506, an absolute grating ruler 507, and a guide rail hard limit stop 508 which are provided on the feed module supporting plate 502. The robot connecting flange 501 is connected with the robot. The feed module supporting plate 502 is connected with the robot connecting flange 501, i.e., one side of the feed module supporting plate 502 provides support for the feed module 5, and the other side is connected with the robot connecting flange 501 as a mechanical interface of the entire machine. The first driving structure 503 and the second driving structure 504 are provided at the middle part of the feed module supporting plate 502. The linear guide rails and accessories thereof 505 are provided at two sides of the feed module supporting plate 502. The sliding blocks and accessories thereof 506 are provided on the linear guide rails and accessories thereof 505. The linear guide rails and accessories thereof 505 are mounted on the feed module supporting plate 502 by high-strength fastening screws, to provide guidance for axial movement of the station switching module 1 and the pressure foot normal leveling module 6 in cooperation with the sliding blocks and accessories thereof 506 respectively provided on the station switching module 1 and the pressure foot normal leveling module 6, thereby ensuring the straightness of feed of the station switching module 1 and the pressure foot normal leveling module 6.

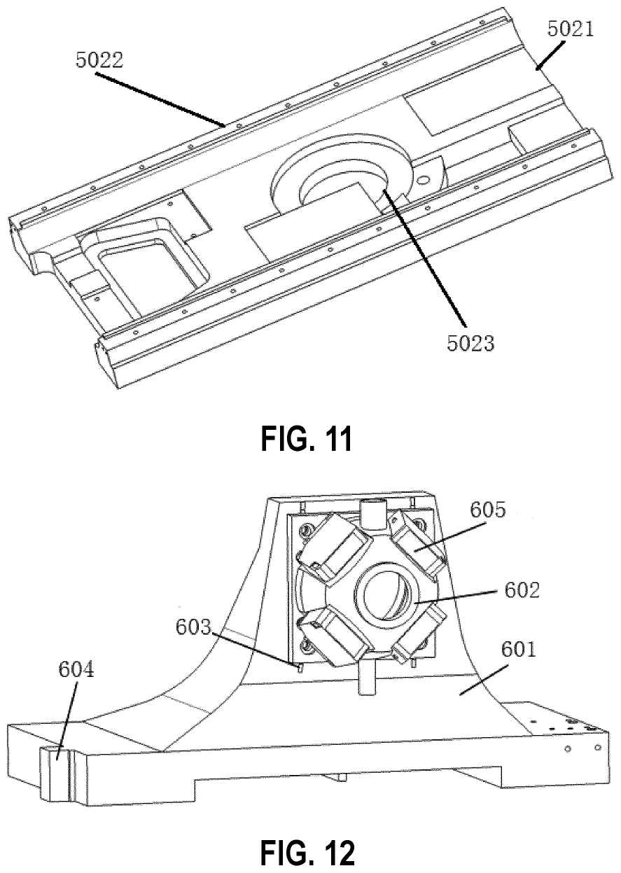

FIG. 11 is a schematic structural diagram of a feed module supporting plate according to an embodiment of the present invention. As shown in FIG. 11, the feed module supporting plate 502 includes a feed module supporting portion 5021, two linear guide rail bearing portions 5022 for bearing the linear guide rails and accessories thereof 505, and a robot connecting flange mounting portion 5023 for mounting the robot connecting flange 501. The linear guide rail bearing portions 5022 are provided at two sides of the feed module supporting portion 5021. The robot connecting flange mounting portion 5023 is provided at the center of the feed module supporting portion 5021.

The first driving structure 503 includes a spindle motor 5031, a speed reducer 5032, a first motor support 5033, a first lead screw 5034, and a first nut seat 5035 in sequence, and is configured to achieve a transmission purpose of increasing torque and decreasing rotation speed. The specific structural relationship is that: the spindle motor 5031, the speed reducer 5032, the first motor support 5033, and the first lead screw 5034 are stably mounted on the feed module supporting plate 502 by a support bearing and a bearing seat. The first motor support 5033 implements coaxial connection among the speed reducer, the coupling in the first motor support 5033, and a lead screw shaft of the first lead screw 5034. The spindle motor 5031 is connected with the first lead screw 5034 by the speed reducer 5032, to achieve the transmission purpose of increasing torque and decreasing rotation speed. The first nut seat 5035 is connected to the dual-station supporting plate 103 by a screw, i.e., the dual-station supporting plate 103 is fixed on the first driving structure 503 by the first nut seat 5035, and is connected with the sliding blocks and accessories thereof 506 to move the station switching module 1. The first driving structure 503 is configured to provide power for feeding the station switching module 1 along the axial direction of the drilled hole.

The second driving structure 504 includes a presser foot motor 5041, a second lead screw 5042, and a second nut seat 5043 in sequence. The second nut seat 5043 is connected to the pressure foot normal leveling module 6 by a screw, i.e., the pressure foot normal leveling module 6 is fixed on the second driving structure 504 by the second nut seat 5043, and is connected with the sliding blocks and accessories thereof 506 to drive the pressure foot normal leveling module 6 to be axially fed along the drilled hole, thereby pressing the panel with a determined pressing force. The second driving structure 504 is configured to provide power for feeding the pressure foot normal leveling module 6 along the axial direction of the drilled hole.

The relative displacement sensor and the absolute displacement grating ruler 507 constitute the measurement and feedback submodule. A fixed portion 5071 of the absolute grating ruler 507 is provided on a side of the feed module supporting plate 502. A movable read head 5072 of the absolute grating ruler 507 is provided at a side of the dual-station supporting plate 103 by a screw and is not located at the same side as the relative displacement sensor. The fixed portion 5071 is provided at the same side as the movable read head 5072. The fixed portion 5071 cooperates with the movable read head 5072, for obtaining information about relative displacement between the dual-station module 1 and the pressure foot normal leveling module 6 when the relative displacement sensor is not within a measuring range, to precisely control a countersinking depth.

The guide rail hard limit stop 508 is provided at the ends of the linear guide rails and accessories thereof 505 close to the panel, and is configured to prevent the dual-station module 1 and the pressure foot normal leveling module 6 from malfunctioning and slipping off, thereby ensuring safety.

FIG. 12 is a schematic structural diagram of a pressure foot normal leveling module according to an embodiment of the present invention. As shown in FIG. 12, the pressure foot normal leveling module 6 includes a pressure foot supporting plate 601, a pressure foot 602 provided at the middle of the pressure foot supporting plate 601 and provided with a center hole, a pressure sensor 603, a relative displacement sensor contact wall structure 604, and laser sensors 605 evenly arranged along the outer edge of the pressure foot 602.

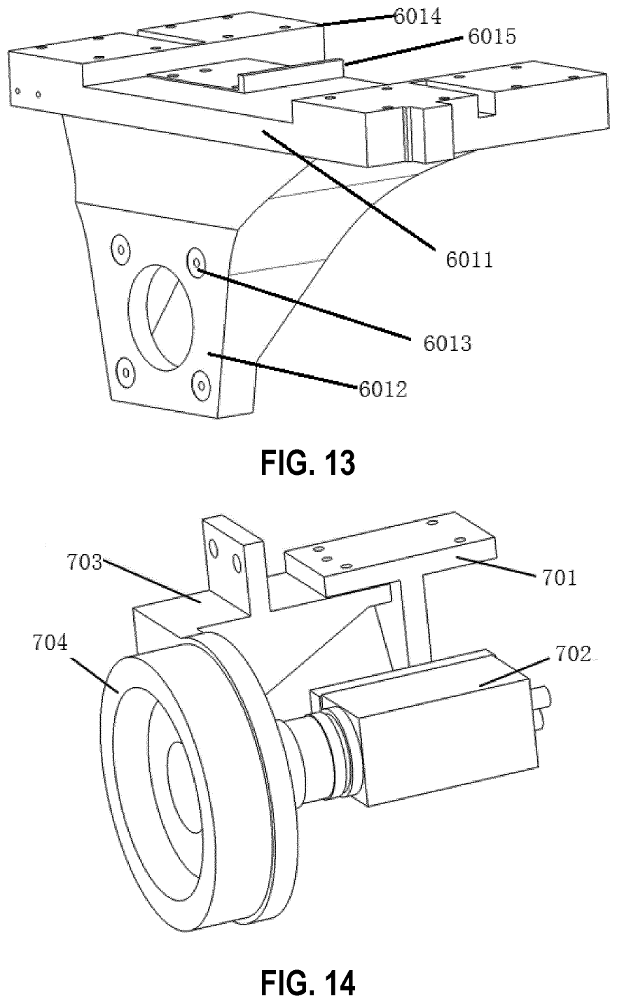

FIG. 13 is a schematic structural diagram of a pressure foot supporting plate according to an embodiment of the present invention. As shown in FIG. 13, the pressure foot supporting plate 601 includes a pressure foot supporting portion 6011, a pressure foot mounting portion 6012, a plurality of laser sensor mounting portions 6013, a plurality of sliding block and accessory mounting portions 6014, and a second nut seat mounting portion 6015. The pressure foot mounting portion 6012 is provided at the center of a surface of the pressure foot supporting portion 6011 and is configured to mount the pressure foot 602 at this position. The plurality of laser sensor mounting portions 6013 is evenly arranged along the outer edge of the pressure foot mounting portion 6012 and is configured to provide the laser sensor 605 at this position. The sliding block and accessory mounting portions 6014 are provided at two sides of the other surface of the pressure foot supporting portion 6011 and is configured to mount the sliding blocks and accessories thereof 506 in the feed module 5 at this position. The second nut seat mounting portion 6015 is provided at the center of the other surfaced of the pressure foot supporting portion 6011 and is configured to mount the second nut seat 5043 in the feed module 5 at this position.

The pressure foot supporting plate 601 is fixed on the second driving structure 504 by the second nut seat 5043 and is connected with the sliding blocks and accessories thereof 506 to move the pressure foot normal leveling module 6. The second driving structure 504 is configured to provide power for feeding the pressure foot normal leveling module 6 along the axial direction of the drilled hole. The laser sensor 605 is obliquely mounted along a certain internal taper of the pressure foot 602 and is configured to obtain information about a relative distance between the center hole of the pressure foot 602 and the panel by panel vector angle adjustment. The pressure sensor 603 is an annular button type pressure sensor, is provided at a connecting bolt hole between the pressure foot 602 and the pressure foot supporting plate 601 and is configured to obtain a pressure value of the pressure foot 602 pressing the panel. The relative displacement sensor contact wall structure 604 is provided at a side of the pressure foot supporting plate 601, and is located at the same side as the relative displacement sensor. The relative displacement sensor contact wall structure 604 cooperates with the relative displacement sensor, for obtaining information about relative displacement between the dual-station module 1 and the pressure foot normal leveling module 6, to precisely control the countersinking depth.

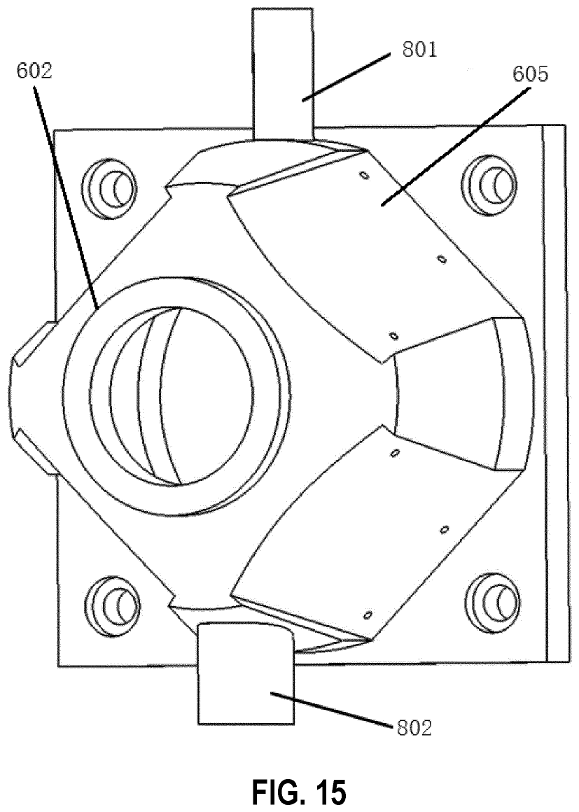

FIG. 14 is a schematic structural diagram of a visual alignment module according to an embodiment of the present invention. As shown in FIG. 14, the visual alignment module 7 includes a visual device supporting plate 701, a visual camera 702 and a visual light source support 703 provided at two sides of the visual device supporting plate 701, and a visual light source portion 704 supported by the visual light source support 703. The visual device supporting plate 701 is provided on the pressure foot supporting plate 601. The visual camera 702 is configured to obtain panel positioning pin/hole position information during visual alignment. The visual light source portion 704 is connected with the end of the visual camera 702 facing toward the panel and is configured to provide a light field for the visual camera 702.

FIG. 15 is a schematic structural diagram of a cooling and dust collecting module according to an embodiment of the present invention. As shown in FIG. 15, the cooling and dust collecting module 8 includes a cooling pipe connector 801 and a dust collecting pipe connector 802. The cooling pipe connector 801 and the dust collecting pipe connector 802 are symmetrically arranged about a vertical axis of the pressure foot 602. One end of the cooling pipe connector 801 opens into the center hole of the pressure foot 602, and the other end is connected with a tool cooling and lubricating device disposed on a platform of the robot; the cooling pipe connector is configured to cool and lubricate a tool when the end effector drills a hole. One end of the dust collecting pipe connector 802 opens into the center hole of the pressure foot 602, and the other end is connected with a dust collecting device disposed on the platform of the robot; the dust collecting pipe connector is configured to remove chips of the panel when the end effector drills the hole.

In the following, high-precision drilling and interference-fit connection of hi-lock bolts are performed on an aircraft panel with curvature by an apparatus for integration of drilling and interference-fit pin insertion provided by the embodiments of the present invention. The specific implementation steps are as follows:

(1) Position alignment of a pre-positioning pin/positioning hole: run an offline planning program of a robot; move the apparatus for integration of drilling and interference-fit pin insertion to a region where the pre-positioning pin/positioning hole is located on a panel by the robot; use a visual camera 702 to photograph and scan the region where the pre-positioning pin/positioning hole is located on the panel; feed back the photographing and scanning result to a control system, so as to obtain a coordinate difference between the center of a visual field and the center of a positioning pin; control the apparatus for integration of drilling and interference-fit pin insertion to move according to the coordinate difference, and then obtain a coordinate difference again; determine whether the coordinate difference reaches a required alignment precision; if the precision requirement is met, stop an alignment cycle; on the contrary, continue to move the apparatus for integration of drilling and interference-fit pin insertion for alignment, and determine the precision, until the precision reaches the required precision range, then end the alignment cycle. By using such a continuous iterative alignment method, the deviation value is reduced to be within an allowable error range.

(2) Normal alignment: after the position alignment of the pre-positioning pin, start four normal laser sensors 605; measure a distance from the center of a center hole of a pressure foot 602 to the panel; feed back the measurement data to the control system for processing; and control a pressure foot normal leveling module 6 to adjust pose, so that the deviation of an angle between axes of the center hole of the pressure foot 602 and the positioning pin is within an allowable error range. Afterwards, the data of the visual alignment module 7 and the pressure foot normal leveling module 6 at this time is recorded as a first set of positioning data.

(3) Move the apparatus for integration of drilling and interference-fit pin insertion to the position of the next positioning pin/positioning hole; repeat steps (1) and (2); record a second set of positioning data; and calculate position coordinates of all holes to be drilled between the two positioning pins/positioning holes according to the first set of positioning data and the second set of positioning data by using a linear interpolation algorithm.

(4) Press the panel with the press foot: after the position alignment of the pre-positioning pin, move the apparatus for integration of drilling and interference-fit pin insertion to a first point to be drilled; a feed module 5 starts to drive the pressure foot normal leveling module 6 to feed; in the feed process, four pressure sensors 603 monitor in real time the pressure of the pressure foot pressing the panel; when the pressing force reaches a set optimum value, the feed module 5 controls the pressure foot normal leveling module 6 to stop feeding, and then locks a motor shaft of a pressure foot motor 5041 by using a motor brake element, until the hole machining ends. It is ensured that the pressure on the panel is constant and no secondary formation occurs in the entire machining process.

(5) Drilling of spindle: after the pressure foot 602 presses the panel, an electric spindle 201 starts to operate, so that a drilling and countersinking integrated tool 204 rotates at a preset parameter, and the feed module 5 drives a spindle module 2 to axially feed the electric spindle 201 and the drilling and countersinking integrated tool 204; in this process, an absolute grating ruler 507 starts to operate, records a feed amount of the electric spindle 201, and adjusts the speed of the electric spindle 201 getting close to the panel; after the relative displacement sensor contacts the front end of the pressure foot 602, the absolute grating ruler 507 starts safety monitoring, and is no longer used for feed displacement control and feedback; the relative displacement sensor monitors in real time the feed amount of the drilling and countersinking integrated tool 204 with respect to the front end of the pressure foot 602, and ensures that drilling and countersinking depths reach a given precision; in addition, the rotation speed of the drilling and countersinking integrated tool 204 is adjusted by adjusting the rotation speed of the electric spindle 201, so that cutting parameters for drilling are optimum operating parameters, and the drilling quality is ensured.

(6) Cooling and dust collection: at an appropriate time after step (5) is started, turn on a cooling and dust collecting module 8 to lubricate and cool the drilling and countersinking integrated tool 204, in order to reduce the temperature of a drilling region and remove chips and dust generated by drilling, thereby ensuring the machining quality and personal safety of an operator.

(7) Station switching: after the drilling is completed, the electric spindle 201 returns to the initial position, a station switching module 1 operates to drive a first station and a second station to perform station state switching, precisely controls the rotation angle by an absolute rotary encoder in a driving servomotor 1011, switches the pin insertion module 3 to a processing station, and ensures the coaxial alignment between a pin insertion spindle 302 and an inner cavity of the pressure foot 602.

(8) Pin feeding and insertion: after the station switching is completed, a pin feeding module 4 feeds hi-lock bolts of an appropriate specification into a bolt clamping portion 304 of a pin insertion module 3; after receiving a pin insertion start signal, the feed module 5 starts to drive the pin insertion module 3 to feed, monitors feedback by the absolute grading ruler 507; after being fed to an appropriate position, the pin insertion module 3 operates, and a pneumatic unit in a pin insertion cylinder 301 presses the hi-lock bolts into holes.

(9) Station switching: after the pin insertion is completed, the pin insertion module 3 returns to the initial position, the station switching module 1 operates to switch the spindle module 2 to the processing station.

(10) Return of the pressure foot: after the station switching is completed, the feed module 5 drives the pressure foot normal leveling module 6 to return to the initial position and locks all motors.

(11) Move to the next hole site to be machined: after drilling and pin insertion at this hole site are completed, the robot is driven by the offline program to drive an end effector to move to the next hole site to be machined.

(12) Repeat the above steps to implement drilling and pin insertion of the next point site.

Compared with the prior art, the present invention achieves the following technical objectives and advantages:

I. A visual alignment module uses a supplemental light source adapted to the color temperature of the machining environment, and an improved alignment algorithm to ensure accurate identification of the pre-positioning hole/pin of the panel and measurement of a deviation value between the origin of the coordinate system of a calculator and a positioning center thereof and controls the robot to compensate for a positioning error between an adjustment device and the product in the mode of iterative correction, thereby ensuring the position precision of the drilled hole.

II. Interference-fit connection of a hi-lock bolt: a hole is drilled at a hole site needing interference-fit connection, and then a hi-lock bolt of a predetermined specification is inserted in the connecting hole in the mode of quasi-static compression, thereby enhancing the connection precision and efficiency.

III. Four laser sensors of a pressure foot normal leveling module are obliquely mounted along a certain internal taper, so that a leveling measurement region on the panel is smaller, thereby achieving a higher leveling precision and avoiding a bias hole or inclined hole.

IV. By using a full-closed-loop force feedback and electric drive control approach, a feed module monitors and feeds back in real time the pressure of a pressure foot pressing the panel by four pressure sensors, and accurately controls the pressure of the pressure foot pressing the panel, so that the pressure becomes an optimum process parameter. Subsequently, a pressure foot motor is locked to ensure that the pressure on the panel is constant and no secondary formation occurs in the machining process. Product injury caused by excessive pressure on the panel is avoided, or damage to the apparatus for integration of drilling and interference-fit pin insertion caused by instantaneous rebound occurring at the end of machining due to the fact that the panel is separated from the front-end face of the pressure foot in the machining process because of insufficient pressing force is avoided.

V. Precise control of drilling and countersinking depths: when a drilling and countersinking integrated tool for drilling and countersinking is fed, a high-precision relative displacement sensor monitors and feeds back in real time a feed distance of the drilling and countersinking integrated tool with respect to the pressure foot, thereby eliminating a countersinking depth error caused by random deformation of the panel under the same pressure due to different local rigidities, to implement precise control of the countersinking depth.

VI. The machining state is safely and intelligently perceived in real time, drilling force and pin insertion force generated during product machining are monitored in real time and fed back to a control system, and a fuzzy algorithm is used to distinguish normal and abnormal machining state feedback values. When unsafe machining states, such blade breakage, spindle abnormalities, and pin skew, occur, the machine can be braked and stopped in time to avoid greater damage to products and equipment.

Therefore, the present invention provides an apparatus for integration of drilling and interference-fit pin insertion. On the basis of ensuring that each of precision indexes, such as position precision, normal precision, surface roughness, and dimension precision, of the drilled hole can well meet the design requirements, a hole is drilled at a hole site needing interference-fit connection, and then a hi-lock bolt having a corresponding diameter is accurately inserted in the hole according to a predetermined interference amount, thereby implementing integration of drilling and interference-fit connection of the hi-lock bolt, improving the stress distribution of a connecting hole under load, and enhancing the anti-fatigue performance and assembly efficiency.

To achieve the above objective, the present invention further provides a method for integration of drilling and interference-fit pin insertion.

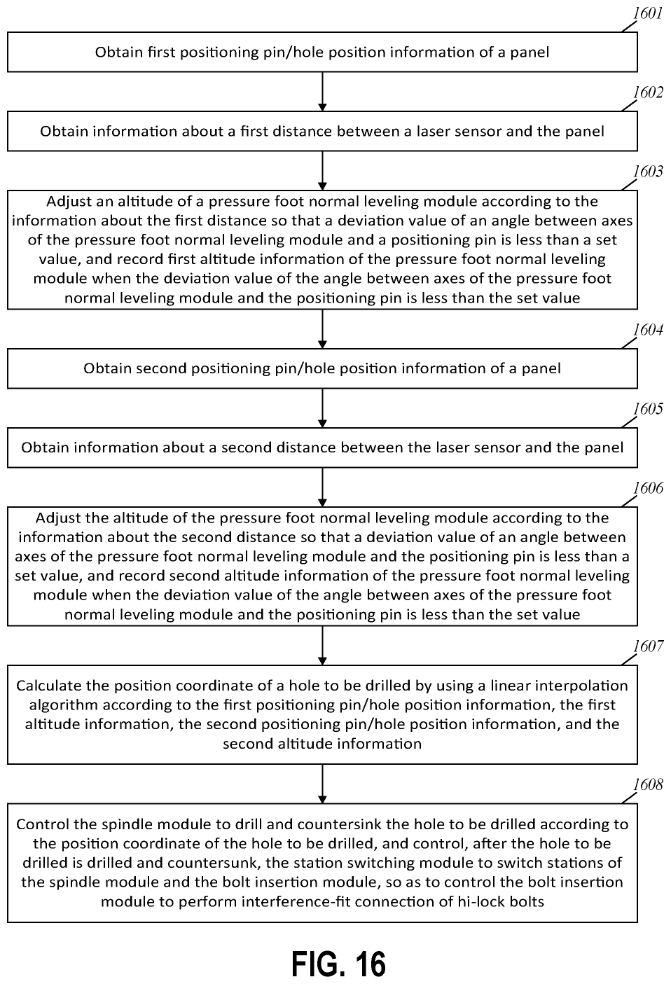

FIG. 16 is a schematic flow chart of a method for integration of drilling and interference-fit pin insertion according to an embodiment of the present invention. As shown in FIG. 16, the method for integration of drilling and interference-fit pin insertion provided by the embodiment of the present invention includes the following steps:

Step 1601: obtaining first positioning pin/hole position information of a panel;

Step 1602: obtaining information about a first distance between a laser sensor and the panel;

Step 1603: adjusting an altitude of a pressure foot normal leveling module according to the information about the first distance so that a deviation value of an angle between axes of the pressure foot normal leveling module and a positioning pin is less than a set value, and recording first altitude information of the pressure foot normal leveling module when the deviation value of the angle between axes of the pressure foot normal leveling module and the positioning pin is less than the set value;

Step 1604: obtaining second positioning pin/hole position information of a panel;

Step 1605: obtaining information about a second distance between the laser sensor and the panel;

Step 1606: adjusting the altitude of the pressure foot normal leveling module according to the information about the second distance so that a deviation value of an angle between axes of the pressure foot normal leveling module and the positioning pin is less than a set value, and recording second altitude information of the pressure foot normal leveling module when the deviation value of the angle between axes of the pressure foot normal leveling module and the positioning pin is less than the set value;

Step 1607: calculating the position coordinate of a hole to be drilled by using a linear interpolation algorithm according to the first positioning pin/hole position information, the first altitude information, the second positioning pin/hole position information, and the second altitude information; and

Step 1608: controlling the spindle module to drill and countersink the hole to be drilled according to the position coordinate of the hole to be drilled, and controlling, after the hole to be drilled is drilled and countersunk, the station switching module to switch stations of the spindle module and the bolt insertion module, so as to control the bolt insertion module to perform interference-fit connection of hi-lock bolts.

The embodiments described above are only descriptions of preferred embodiments of the present invention, and do not intended to limit the scope of the present invention. Various variations and modifications can be made to the technical solution of the present invention by those of ordinary skills in the art, without departing from the design and spirit of the present invention. The variations and modifications should all fall within the claimed scope defined by the claims of the present invention.

What is claimed is:

1. An apparatus for integration of drilling and interference-fit pin insertion, which is connected with a robot, wherein the apparatus for integration of drilling and interference-fit pin insertion comprises:
a station switching module,
a spindle module, and
a pin insertion module;
the station switching module comprises a driving mechanism, a dual-station connecting plate, and a connecting belt mechanism connected between the driving mechanism and the dual-station connecting plate; the connecting belt mechanism is fixedly connected with the dual-station connecting plate;
the spindle module is provided at a first station of the dual-station connecting plate, and is configured to drill and countersink a panel connecting hole;
the pin insertion module is provided at a second station of the dual-station connecting plate, and is configured for interference-fit pin insertion of hi-lock bolts; and
the driving mechanism of the station switching module drives the connecting belt mechanism to rotate, so as to implement station switching between the first station and the second station.

2. The apparatus for integration of drilling and interference-fit pin insertion according to claim 1, wherein the station switching module further comprises:
a dual-station supporting plate,
a roller shaft collar, and
a relative displacement sensor;
the dual-station supporting plate is provided below the dual-station connecting plate, and is configured to support the dual-station connecting plate; the dual-station connecting plate comprises a first portion and a second portion; the roller shaft collar is embedded into a center of the first portion; the relative displacement sensor is provided at a side of the dual-station supporting plate; the driving mechanism comprises a driving servomotor, a motor support, a bearing seat, a lead screw, and a nut seat in sequence; an external thread is provided outside one end of the nut seat; an internal thread is provided inside the connecting belt mechanism; the internal thread matches the external thread; the nut seat is connected with the connecting belt mechanism by the internal thread and the external thread matching each other; one end of the lead screw passes through the other end of the nut seat, and the other end of the lead screw passes through the bearing seat to connect with a coupling in the motor support and a motor shaft in the driving servomotor in sequence, and is configured to implement power connection between the dual-station connecting plate and the dual-station supporting plate, wherein the bearing seat is provided on the dual-station supporting plate.

3. The apparatus for integration of drilling and interference-fit pin insertion according to claim 2, wherein the first portion is a hollow circular structure; the second portion is a sector structure, and an internal arc edge of the sector structure is fixedly connected with an external circular surface of the hollow circular structure; the first station and the second station are provided on the sector structure.

4. The apparatus for integration of drilling and interference-fit pin insertion according to claim 1, wherein the spindle module comprises:
a spindle collet,
an electric spindle,
a WK tool shank, and
a drilling and countersinking integrated tool in sequence;
the spindle collet is provided at the first station; the electric spindle passes through the spindle collet to connect with one end of the WK tool shank; the drilling and countersinking integrated tool is provided at the other end of the WK tool shank, and is configured to drill and countersink a panel connecting hole.

5. The apparatus for integration of drilling and interference-fit pin insertion according to claim 1, wherein the pin insertion module comprises:
a pin insertion cylinder,
a pin insertion spindle,
a chuck connecting plate, and
a bolt clamping portion in sequence;
the pin insertion cylinder is provided at the second station; one end of the pin insertion spindle is coaxially connected with a cylinder piston rod shaft in the pin insertion cylinder, and the other end of the pin insertion spindle passes through the chuck connecting plate to connect with a pin insertion passage in the bolt clamping portion, for implementing interference-fit pin insertion of the hi-lock bolts, wherein a hi-lock bolt altitude detection sensor is provided in the bolt clamping portion, and is configured to obtain altitude information of the hi-lock bolts.

6. The apparatus for integration of drilling and interference-fit pin insertion according to claim 5, wherein the apparatus further comprises:
a pin feeding module; the pin feeding module comprises a pin feeding chuck passage, an end pin-feeding pipe, a pipe integrator, a hopper pin-feeding pipe, and a hopper device in sequence;
the pin feeding chuck passage is connected with the pin insertion passage in the bolt clamping portion, and is configured to supply hi-lock bolts of different specifications for the bolt clamping portion; one end of the pipe integrator is connected with the pin feeding chuck passage by the end pin-feeding pipe, and the other end of the pipe integrator is connected with the hopper device by the hopper pin-feeding pipe, wherein there are multiple hopper pin-feeding pipes; the hopper device is configured to store the hi-lock bolts of different specifications and automatically sort the hi-lock bolts.

7. The apparatus for integration of drilling and interference-fit pin insertion according to claim 2, wherein the apparatus for integration of drilling and interference-fit pin insertion further comprises:
a feed module; the feed module comprises a robot connecting flange, a feed module supporting plate, as well as a first driving structure, a second driving structure, two sets of linear guide rails and accessories thereof, a plurality of sliding blocks and accessories thereof, an absolute grating ruler, and a guide rail hard limit stop which are provided on the feed module supporting plate;
the robot connecting flange is connected with the robot; the feed module supporting plate is connected with the robot connecting flange; the first driving structure and the second driving structure are provided at a middle part of the feed module supporting plate, and the linear guide rails and accessories thereof are provided at two sides of the feed module supporting plate; the sliding blocks and accessories thereof are provided on the linear guide rails and accessories thereof; the first driving structure comprises a spindle motor, a speed reducer, a first motor support, a first lead screw, and a first nut seat in sequence, and is configured to achieve a transmission purpose of increasing torque and decreasing rotation speed; the second driving structure comprises a presser foot motor, a second lead screw, and a second nut seat in sequence; a fixed portion of the absolute grating ruler is provided at a side of the feed module supporting plate; a movable read head of the absolute grating ruler is provided at a side of the dual-station supporting plate by a screw, and is not located at the same side as the relative displacement sensor; the fixed portion is provided at the same side as the movable read head; the fixed portion cooperates with the movable read head, for obtaining information about relative displacement between the station switching module and a pressure foot normal leveling module when the relative displacement sensor is not within a measuring range; the guide rail hard limit stop is provided at ends of the linear guide rails and accessories thereof close to a panel, and is configured to prevent the station switching module and the pressure foot normal leveling module from malfunctioning and slipping off, thereby ensuring safety, wherein the dual-station supporting plate is fixed on the first driving structure by of the first nut seat, and is connected with the sliding blocks and accessories thereof to move the station switching module; the first driving structure is configured to provide power for feeding the station switching module along an axial direction of a drilled hole.

8. The apparatus for integration of drilling and interference-fit pin insertion according to claim 7, wherein the apparatus for integration of drilling and interference-fit pin insertion further comprises:
a pressure foot normal leveling module; the pressure foot normal leveling module comprises a pressure foot supporting plate, a pressure foot provided at the middle of the pressure foot supporting plate and provided with a center hole, a pressure sensor, a relative displacement sensor contact wall structure, and laser sensors evenly arranged along an outer edge of the pressure foot;
the pressure foot supporting plate is fixed above the second driving structure by the second nut seat, and is connected with the sliding blocks and accessories thereof to move the pressure foot normal leveling module; the second driving structure is configured to provide power for feeding the pressure foot normal leveling module along the axial direction of the drilled hole; the laser sensor is configured to obtain information about a relative distance between the pressure foot and the panel; the pressure sensor is provided at a connecting bolt hole between the pressure foot and the pressure foot supporting plate, and is configured to obtain a pressure value of the pressure foot pressing the panel; the relative displacement sensor contact wall structure is provided at a side of the pressure foot supporting plate, and is located at the same side as the relative displacement sensor; the relative displacement sensor contact wall structure cooperates with the relative displacement sensor, and is configured to obtain information about relative displacement between the station switching module and the pressure foot normal leveling module, thereby precisely controlling a countersinking depth.

9. The apparatus for integration of drilling and interference-fit pin insertion according to claim 8, wherein the apparatus for integration of drilling and interference-fit pin insertion further comprises:
a visual alignment module, and
a cooling and dust collecting module,
wherein the visual alignment module comprises a visual device supporting plate, a visual camera and a visual light source support provided at two sides of the visual device supporting plate, and a visual light source portion supported by the visual light source support; the visual device supporting plate is provided on the pressure foot supporting plate; the visual camera is configured to obtain panel positioning pin/hole position information; the visual light source portion is connected with an end of the visual camera facing toward the panel, and is configured to provide a light field for the visual camera;
the cooling and dust collecting module comprises a cooling pipe connector and a dust collecting pipe connector; the cooling pipe connector and the dust collecting pipe connector are symmetrically arranged about a vertical axis of the pressure foot; one end of the cooling pipe connector opens into the center hole of the pressure foot, and the other end is connected with a tool cooling and lubricating device disposed on a platform of the robot; the cooling pipe connector is configured to cool and lubricate a tool when the end effector drills a hole; one end of the dust collecting pipe connector opens into the center hole of the pressure foot, and the other end is connected with a dust collecting device disposed on the platform of the robot; the dust collecting pipe connector is configured to remove chips of the panel when the end effector drills the hole.

10. A method for integration of drilling and interference-fit pin insertion, the method for integration of drilling and interference-fit pin insertion comprising:
providing the apparatus for integration of drilling and interference-fit pin insertion of claim 1;
obtaining first positioning pin/hole position information of a panel;
obtaining information about a first distance between a laser sensor and the panel;
adjusting an altitude of a pressure foot normal leveling module according to the information about the first distance so that a deviation value of an angle between axes of the pressure foot normal leveling module and a positioning pin is less than a set value, and recording first altitude information of the pressure foot normal leveling module when the deviation value of the angle between axes of the pressure foot normal leveling module and the positioning pin is less than the set value;
obtaining second positioning pin/hole position information of the panel;
obtaining information about a second distance between the laser sensor and the panel;
adjusting the altitude of the pressure foot normal leveling module according to the information about the second distance so that a deviation value of an angle between axes of the pressure foot normal leveling module and the positioning pin is less than a set value, and recording second altitude information of the pressure foot normal leveling module when the deviation value of the angle between axes of the pressure foot normal leveling module and the positioning pin is less than the set value;
calculating a position coordinate of a hole to be drilled by using a linear interpolation algorithm according to the first positioning pin/hole position information, the first altitude information, the second positioning pin/hole position information, and the second altitude information; and
controlling the spindle module to drill and countersink the hole to be drilled according to the position coordinate of the hole to be drilled, and controlling, after the hole to be drilled is drilled and countersunk, the station switching module to switch stations of the spindle module and the pin insertion module, so as to control the pin insertion module to perform interference-fit connection of hi-lock bolts.

11. The method of claim 10, wherein the station switching module further comprises:
a dual-station supporting plate,
a roller shaft collar, and
a relative displacement sensor;
the dual-station supporting plate is provided below the dual-station connecting plate, and is configured to support the dual-station connecting plate; the dual-station connecting plate comprises a first portion and a second portion; the roller shaft collar is embedded into a center of the first portion; the relative displacement sensor is provided at a side of the dual-station supporting plate; the driving mechanism comprises a driving servomotor, a motor support, a bearing seat, a lead screw, and a nut seat in sequence; an external thread is provided outside one end of the nut seat; an internal thread is provided inside the connecting belt mechanism; the internal thread matches the external thread; the nut seat is connected with the connecting belt mechanism by the internal thread and the external thread matching each other; one end of the lead screw passes through the other end of the nut seat, and the other end of the lead screw passes through the bearing seat to connect with a coupling in the motor support and a motor shaft in the driving servomotor in sequence, and is configured to implement power connection between the dual-station connecting plate and the dual-station supporting plate, wherein the bearing seat is provided on the dual-station supporting plate.

12. The method of claim 11, wherein the first portion is a hollow circular structure; the second portion is a sector structure, and an internal arc edge of the sector structure is fixedly connected with an external circular surface of the hollow circular structure; the first station and the second station are provided on the sector structure.

13. The method of claim 10, wherein the spindle module comprises:
a spindle collet,
an electric spindle,
a WK tool shank, and
a drilling and countersinking integrated tool in sequence;
the spindle collet is provided at the first station; the electric spindle passes through the spindle collet to connect with one end of the WK tool shank; the drilling and countersinking integrated tool is provided at the other end of the WK tool shank and is configured to drill and countersink a panel connecting hole.

14. The method of claim 10, wherein the pin insertion module comprises:
a pin insertion cylinder,
a pin insertion spindle,
a chuck connecting plate, and
a bolt clamping portion in sequence;
the pin insertion cylinder is provided at the second station; one end of the pin insertion spindle is coaxially connected with a cylinder piston rod shaft in the pin insertion cylinder, and the other end of the pin insertion spindle passes through the chuck connecting plate to connect with a pin insertion passage in the bolt clamping portion, for implementing interference-fit pin insertion of the hi-lock bolts, wherein a hi-lock bolt altitude detection sensor is provided in the bolt clamping portion, and is configured to obtain altitude information of the hi-lock bolts.

15. The method of claim 14, wherein the apparatus further comprises:
a pin feeding module; the pin feeding module comprises a pin feeding chuck passage, an end pin-feeding pipe, a pipe integrator, a hopper pin-feeding pipe, and a hopper device in sequence;
the pin feeding chuck passage is connected with the pin insertion passage in the bolt clamping portion, and is configured to supply hi-lock bolts of different specifications for the bolt clamping portion; one end of the pipe integrator is connected with the pin feeding chuck passage by the end pin-feeding pipe, and the other end of the pipe integrator is connected with the hopper device by the hopper pin-feeding pipe, wherein there are multiple hopper pin-feeding pipes; the hopper device is configured to store the hi-lock bolts of different specifications and automatically sort the hi-lock bolts.

16. The method of claim 11, wherein the apparatus for integration of drilling and interference-fit pin insertion further comprises:
a feed module; the feed module comprises a robot connecting flange, a feed module supporting plate, as well as a first driving structure, a second driving structure, two sets of linear guide rails and accessories thereof, a plurality of sliding blocks and accessories thereof, an absolute grating ruler, and a guide rail hard limit stop which are provided on the feed module supporting plate;
the robot connecting flange is connected with the robot; the feed module supporting plate is connected with the robot connecting flange; the first driving structure and the second driving structure are provided at a middle part of the feed module supporting plate, and the linear guide rails and accessories thereof are provided at two sides of the feed module supporting plate; the sliding blocks and accessories thereof are provided on the linear guide rails and accessories thereof; the first driving structure comprises a spindle motor, a speed reducer, a first motor support, a first lead screw, and a first nut seat in sequence, and is configured to achieve a transmission purpose of increasing torque and decreasing rotation speed; the second driving structure comprises a presser foot motor, a second lead screw, and a second nut seat in sequence; a fixed portion of the absolute grating ruler is provided at a side of the feed module supporting plate; a movable read head of the absolute grating ruler is provided at a side of the dual-station supporting plate by a screw, and is not located at the same side as the relative displacement sensor; the fixed portion is provided at the same side as the movable read head; the fixed portion cooperates with the movable read head, for obtaining information about relative displacement between the station switching module and a pressure foot normal leveling module when the relative displacement sensor is not within a measuring range; the guide rail hard limit stop is provided at ends of the linear guide rails and accessories thereof close to a panel, and is configured to prevent the station switching module and the pressure foot normal leveling module from malfunctioning and slipping off, thereby ensuring safety, wherein the dual-station supporting plate is fixed on the first driving structure by the first nut seat, and is connected with the sliding blocks and accessories thereof to move the station switching module; the first driving structure is configured to provide power for feeding the station switching module along an axial direction of a drilled hole.

17. The method of claim 16, wherein the apparatus for integration of drilling and interference-fit pin insertion further comprises:
a pressure foot normal leveling module; the pressure foot normal leveling module comprises a pressure foot supporting plate, a pressure foot provided at the middle of the pressure foot supporting plate and provided with a center hole, a pressure sensor, a relative displacement sensor contact wall structure, and laser sensors evenly arranged along an outer edge of the pressure foot;
the pressure foot supporting plate is fixed above the second driving structure by the second nut seat, and is connected with the sliding blocks and accessories thereof to move the pressure foot normal leveling module; the second driving structure is configured to provide power for feeding the pressure foot normal leveling module along the axial direction of the drilled hole; the laser sensor is configured to obtain information about a relative distance between the pressure foot and the panel; the pressure sensor is provided at a connecting bolt hole between the pressure foot and the pressure foot supporting plate, and is configured to obtain a pressure value of the pressure foot pressing the panel; the relative displacement sensor contact wall structure is provided at a side of the pressure foot supporting plate, and is located at the same side as the relative displacement sensor; the relative displacement sensor contact wall structure cooperates with the relative displacement sensor, and is configured to obtain information about relative displacement between the station switching module and the pressure foot normal leveling module, thereby precisely controlling a countersinking depth.

18. The method of claim 17, wherein the apparatus for integration of drilling and interference-fit pin insertion further comprises:
a visual alignment module, and
a cooling and dust collecting module,
wherein the visual alignment module comprises a visual device supporting plate, a visual camera and a visual light source support provided at two sides of the visual device supporting plate, and a visual light source portion supported by the visual light source support; the visual device supporting plate is provided on the pressure foot supporting plate; the visual camera is configured to obtain panel positioning pin/hole position information; the visual light source portion is connected with an end of the visual camera facing toward the panel, and is configured to provide a light field for the visual camera;
the cooling and dust collecting module comprises a cooling pipe connector and a dust collecting pipe connector; the cooling pipe connector and the dust collecting pipe connector are symmetrically arranged about a vertical axis of the pressure foot; one end of the cooling pipe connector opens into the center hole of the pressure foot, and the other end is connected with a tool cooling and lubricating device disposed on a platform of the robot; the cooling pipe connector is configured to cool and lubricate a tool when the end effector drills a hole; one end of the dust collecting pipe connector opens into the center hole of the pressure foot, and the other end is connected with a dust collecting device disposed on the platform of the robot; the dust collecting pipe connector is configured to remove chips of the panel when the end effector drills the hole.
